(19) United States
(12) Patent Application Publication
(10) Pub. No.: US 2009/0245583 A1
(43) Pub. Date: Oct. 1, 2009

(54) ROAD SHAPE ESTIMATING DEVICE, ROAD SHAPE ESTIMATING METHOD AND PROGRAM

(75) Inventors: Masataka Fukumoto, Anjo-shi (JP); Hiroaki Sugiura, Okazaki-shi (JP); Takayuki Toujyou, Okazaki-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/411,831

(22) Filed: Mar. 26, 2009

(30) Foreign Application Priority Data
Mar. 28, 2008 (JP) 2008-087902

(51) Int. Cl. G06K 9/00

(52) U.S. Cl. 382/104

(57) ABSTRACT

A road shape estimating device has a data obtaining processing unit for obtaining interpolation point data for a plurality of shape interpolation points which represent a shape of a road, a radius calculation processing unit for calculating a radius of curvature at each of shape interpolation points based on the interpolation point data, a corner detection processing unit detecting a corner based on the calculated radius of curvature, and a corner dividing processing unit for obtaining segment lengths of segments between respective shape interpolation points in the corner and dividing the corner by a segment length equal to or larger than a threshold which is set corresponding to an average value of the respective segment lengths.

### INCORPORATION BY REFERENCE

The disclosure of Japanese Patent Application No. 2008-087902 filed on Mar. 28, 2008, including the specification, drawings and abstract, is incorporated herein by reference in its entirety.

### BACKGROUND OF THE INVENTION

The present invention relates to a road shape estimating device, a road shape estimating method and a program.

### Description of the Related Art

Conventionally in a navigation device, the actual location, namely, the current location of a vehicle is detected, for example, by a global locationing system (GPS), map data is read from a data recording unit, a map screen is formed on a display unit, and a map or the like of the current vehicle location and the area surrounding the current vehicle location are displayed on the map screen. Therefore, a driver can drive the vehicle guided by the display on the map screen.

Further, when the driver inputs a destination and sets a search condition, a route search is conducted based on the search condition, and a route from the place of departure, represented by the current location, to the destination is searched for in the map data. Then the route located by the search (“searched route”) is displayed together with the vehicle location on the map screen, and route guidance along the searched route is provided. Therefore, the driver is assisted in driving the vehicle along the displayed searched route.

There is also known a vehicle control system that changes the shift speed of the automatic transmission or output of the engine, using information obtained by the navigation device, so as to control travel of the vehicle.

A road shape estimating device is provided in the latter vehicle control system. The road shape estimating device reads road data from a database provided in the data recording unit of the navigation device so as to obtain interpolation point data for a plurality of interpolation points set to represent a road shape, i.e., shape interpolation points. The road shape estimating device then calculates the radius of curvature (hereinafter, simply referred to as “radius”) of the road between shape interpolation points by means of the three-point calculation method, detects and sets a corner based on each radius, sets a candidate start point for the corner and sets a candidate end point for the corner. Further, the road shape estimating device corrects the positions of the candidate start point and the candidate end point based on a clothoid curve which is an approximate expression of the corner, estimates the road shape, and records the corrected positions of the candidate start point and the candidate end point as data representing the road shape in the recording unit (refer to, for example, Japanese Patent Application Publication No. JP-A-2005-214839).

### SUMMARY OF THE INVENTION

In the conventional road shape estimating device, however, depending on the manner in which the shape interpolation points are recorded (set) in the database, it is possible that a plurality of actual corners on the road will be detected as one corner.

Consequently, the road shape cannot be estimated precisely.

It is an object of the present invention to solve the problem of the conventional road shape estimating device, and to provide a road shape estimating device, a road shape estimating method and a program which are capable of precisely estimating a road shape.

To achieve the object, a road shape estimating device according to the present invention has a data obtaining processing unit for obtaining interpolation point data for a plurality of shape interpolation points which are set along a road and represent the shape of the road, a radius calculation processing unit for calculating a radius of curvature at each of the shape interpolation points based on the interpolation point data for a predetermined section of the road, a corner detection processing unit for detecting a corner in the section based on the radius of curvature at each of the shape interpolation points, and a corner dividing processing unit for obtaining segment lengths of each of the segments between respective shape interpolation points in the detected corner and for dividing the corner by a segment having a segment length equal to or larger than a threshold which is set corresponding to an average value of the segment lengths.

According to the present invention, by dividing of a corner by a segment having a segment length equal to or larger than a threshold which is set corresponding to an average value of the segment lengths of segments between respective shape interpolation points in a detected corner, even if the precision of the interpolation point data in the database is low and a predetermined shape interpolation point is not set for a straight section of a corner, the corner is appropriately divided. Therefore, corners that should be regarded as a plurality of corners will not erroneously be treated as one corner, and thus the road shape can be precisely estimated.

### BRIEF DESCRIPTION OF THE DRAWINGS

FIG. 1A is a block diagram of a vehicle control system in an embodiment of the present invention; and FIG. 1B is a block diagram of the functional components of the road shape estimation processing unit of the CPU 31 in the embodiment of FIG. 1A;

FIG. 2 is a main flowchart of operation of a road shape estimation processing device in the embodiment of FIG. 1A;

FIG. 3 is a flowchart of a subroutine for radius calculation;

FIG. 4 is a diagram explaining the principle of calculating a radius of curvature in the present invention;

FIG. 5 is a first diagram illustrating corner detection in the present invention;

FIG. 6 is a second diagram illustrating corner detection processing in the present invention;

FIG. 7 is a third diagram illustrating corner detection in the present invention;

FIG. 8 is a fourth diagram illustrating corner detection in the present invention;

FIG. 9 is a fifth diagram illustrating corner detection in the present invention;

FIG. 10 is a sixth diagram illustrating corner detection in the present invention;

FIG. 11 is a seventh diagram illustrating corner detection in the present invention;

FIG. 12 is an eighth diagram illustrating corner detection in the present invention;

FIG. 13 is a ninth diagram illustrating corner detection in the present invention;

FIG. 14 is a flowchart of a subroutine of a first embodiment of corner dividing in the present invention;

FIG. 15 is a first diagram explaining the first embodiment of corner dividing in the present invention;

FIG. 16 is a second diagram explaining the first embodiment of corner dividing processing in the present invention;

FIG. 17 is a third diagram explaining the first embodiment of corner dividing in the present invention;

FIG. 18 is a fourth diagram explaining the first embodiment of corner dividing processing in the present invention;

FIG. 19 is a tenth diagram illustrating corner detection in the present invention;

FIG. 20 is a flowchart of a subroutine of a second embodiment of corner dividing in the present invention;

FIG. 21 is a first diagram explaining the second embodiment of corner dividing in the present invention;

FIG. 22 is a second diagram explaining the second embodiment of corner dividing in the present invention;

FIG. 23 is a third diagram explaining the second embodiment of corner dividing in the present invention

FIG. 24 shows one embodiment of a clothoid coefficient map utilized in the present invention;

FIG. 25 is a flowchart of a subroutine for clothoid curve calculation in the present invention; and

FIG. 26 is a diagram explaining fitting in the present invention.

### DESCRIPTION OF THE PREFERRED EMBODIMENTS

A preferred embodiment of the present invention will now be described with reference to the drawings.

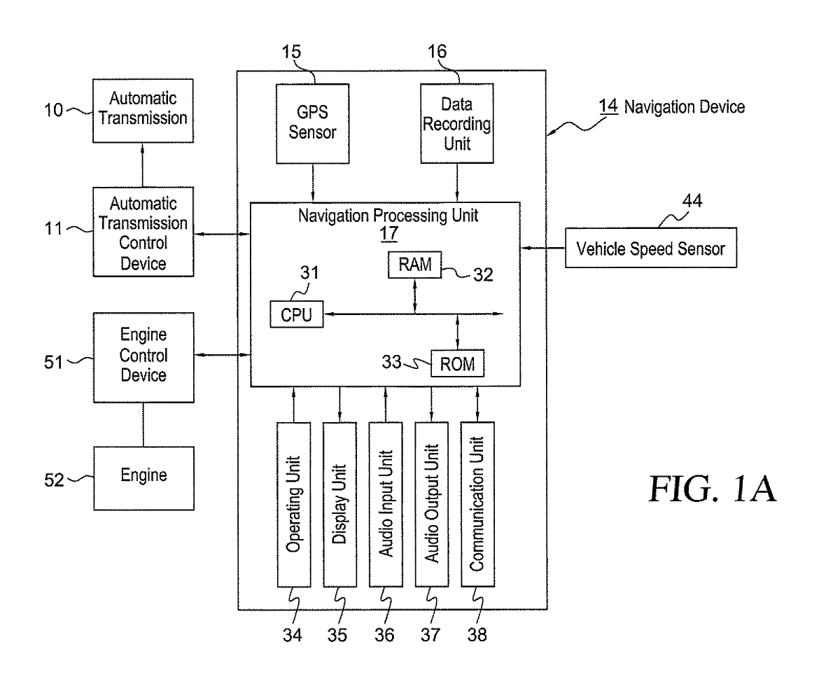

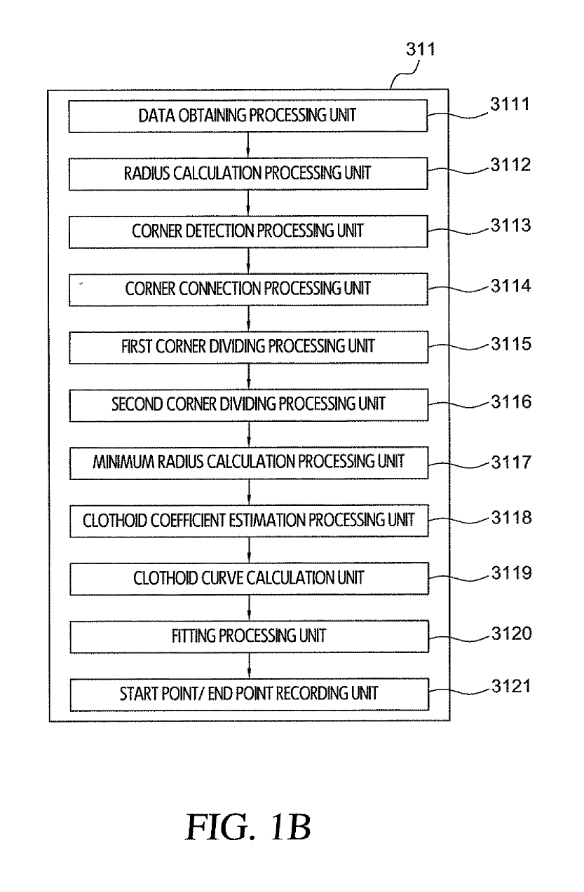

FIG. 1A shows a preferred embodiment of a vehicle control system in accordance with the present invention as including an information terminal 14, for example a navigation device, as an on-board device mounted in a vehicle. The navigation device 14 includes a OPS sensor 15 as a current location detecting unit which detects the current location of the host vehicle (in which unit 14 is mounted) and the direction of the host vehicle, a data recording unit 16 as an information recording unit in which various information including map data is recorded, a navigation processing unit 17 which executes various calculation routines such as a navigation routine, an operation unit 34 serving as a first input unit through which the driver (operator) may input commands and information, a display unit 35 serving as a first output unit for displaying various types of images on a screen for informing the driver, an audio input unit 36 serving as a second input unit with which the driver makes input by voice, an audio output unit 37 serving as a second output unit for audio output providing the driver with various information, and a communication unit 38 serving as a transmission/reception unit (communication terminal). The GPS sensor 15, data recording unit 16, operation unit 34, display unit 35, audio input unit 36, audio output unit 37 and communication unit 38 are connected to the navigation processing unit 17. Further, a vehicle speed sensor 44 (vehicle speed detecting unit), which detects vehicle speed is connected to the navigation processing unit 17. The GPS sensor 15 detects time in addition to the vehicle location and the vehicle direction. A direction sensor (not shown) may also be provided independently from the GPS sensor 15 for detecting the vehicle direction.

The data recording unit 16 contains a database including a map data file containing map data. The map data includes road data representing roads connecting intersections (including branch points), node data representing nodes (start points and end points) of the roads, intersection data regarding the intersections, search data for searching, facility data for various facilities, as well as feature data for features on the road. Further, the road data includes data representing road links connecting start points with end points of the roads, and data for shape interpolation points (hereinafter referred to as “interpolation point data”) as a plurality of points which are set along roads to represent road shapes. The interpolation point data includes the numbers, coordinates, and the like for the shape interpolation points. Note that each node represents a start point or end point on a road link, and hence is also a shape interpolation point.

The data recording unit 16 contains a database of a statistical data file, a database of a traveling history data file, and the like. Statistical data is recorded in the statistical data file, and traveling history data is recorded in the traveling history data file, both as actual data.

The data recording unit 16 includes a disk (not shown) such as a hard drive, CD, DVD or optical disk for recording the various aforementioned data, and further includes a reading/writing head for reading or writing various data. Further, a memory card or the like can be used for the data recording unit 16.

The navigation processing unit 17 has a CPU 31 as a control device for overall control of the navigation device 14 and as an arithmetic unit, a RAM 32 used as a working memory when the CPU 31 performs various arithmetic processing, a ROM 33 in which various programs for searching for a route to a destination, route guidance, and the like are recorded in addition to a control program, a flash memory (not shown) used for recording various data and programs, and the like.

As the operation unit 34, a keyboard (not shown), mouse, and/or the like, may be provided independently from the display unit 35. Further, a touch panel may be used as the operation unit 34 to allow input by touching or clicking image operation units such as various keys, switches, buttons, and the like which are displayed as images on a screen on the display unit 35. The display unit 35 allows display of various screens showing the vehicle location, vehicle direction and the like, as well as a map, the searched route, guidance information for guidance along the searched route, traffic information, and so on, and display of the distance to the next intersection on the searched route and traveling direction at the next intersection.

The audio input unit 36 is a microphone or the like, for input of necessary information by voice. The audio output unit 37 includes an audio synthesis device and a speaker, and provides route guidance along the searched route by audio output.

The communication unit 38 includes a beacon receiver for receiving various items of information such as current traffic information and general information transmitted from a vehicle information and communication system center, a FM receiver for receiving the various FM multiplex broadcasts from FM broadcast stations. Further, the communication unit 38 is able to receive data such as map data, statistical data, and traveling history data, in addition to information such as traffic information and general information from a remote information center (not shown).

The navigation processing unit 17, CPU 31, and so on function as a computer, independently or in a combination of two or more of them, and performs arithmetic processing based on various programs and data. Further, the data recording unit 16, RAM 32, ROM 33, flash memory, and so on serve as a storage device and a recording medium. As the arithmetical unit, a MPU or the like can be used instead of the CPU 31.

FIG. 1A also shows an automatic transmission 10, an automatic transmission control device 11, an engine control unit 51, and an engine 52.

Next, the basic operation of the above-described navigation device 14 will be explained.

First, the operation unit 34 is operated by the driver to start operation of the navigation device 14, a current location reading processing unit (not shown) of the CPU 31 executes a current location reading routine so as to read the vehicle location and the vehicle direction detected by the GPS sensor 15. Then a matching processing unit (not shown) of the CPU 31 performs matching processing and identifies the vehicle location by determining the road link on which the vehicle is located based on the trace of the read vehicle location and shapes, arrangements, and the like of road links forming roads in the surrounding area of the vehicle position.

Subsequently, a basic information obtaining processing unit (not shown) of the CPU 31 performs basic information obtaining processing to read and obtain the map data from the data recording unit 16. Note that the map data can be obtained from the information center or the like, and in this case, the basic information obtaining processing unit downloads the received map data into the flash memory.

A display processing unit (not shown) of the CPU 31 executes display processing to form various screens on the display unit 35. For example, a map display processing unit of the display processing unit executes map display processing to form a map screen on the display unit 35, which map screen presents a map of the surrounding area (vicinity) with additional display of the vehicle location and the vehicle direction.

Therefore, the driver can drive the vehicle guided by the displayed map, the vehicle location and the vehicle direction.

When the driver inputs a destination through the operation unit 34, a destination setting processing unit (not shown) of the CPU 31 executes a destination setting routine. A place of departure can also be input and set as necessary. Further, it is possible to register a predetermined point in advance, and to set the registered point as a destination. Subsequently, when the driver inputs a search condition by operating the operation unit 34, a search condition setting processing unit (not shown) of the CPU 31 executes a search condition setting routine to set the search condition.

When the destination and the search condition have been set in this manner, a route search unit (not shown) of the CPU 31 reads the vehicle position, vehicle direction, destination, search condition and the like and also reads the search data from the data recording unit 16, searches for a route from a place of departure represented by the current vehicle location to the destination under the search condition, and outputs route data representing the thus determined route (“searched route”). In the route search, the route having a smallest sum of link costs for its respective links is taken as the searched route. The place of departure can be a predetermined point set by the driver instead of the current vehicle location, so as to search for a route from the predetermined point to the destination.

Subsequently, a guidance processing unit (not shown) of the CPU 31 executes guidance processing to provide route guidance. For this purpose, a guidance display processing subunit of the guidance processing unit executes guidance display processing to read the route data and display the searched route on the map screen based on the route data.

When it is necessary, for example, to turn the vehicle to the right or left at an intersection that is a point which is a subject of route guidance, the intersection is set as a guidance intersection where guidance as to direction for advancing the vehicle is to be given. An audio output processing subunit of the guidance processing unit then executes audio output processing to provide the route guidance by audio output in advance of the point where the vehicle enters the guidance intersection.

A guidance point enlarged view formation processing subunit of the guidance processing unit forms an enlarged view of the guidance intersection, in a predetermined region of the map screen, in advance of the vehicle reaching the guidance intersection. For this purpose, when the vehicle reaches a location that is a set distance in advance of (on the vehicle position side of) the guidance intersection on the searched route, the intersection enlarged view is displayed. In this case, a map of the guidance intersection, the searched route, and a landmark, e.g. facility, at the guidance intersection are displayed on the intersection enlarged view.

In this embodiment, information obtained in the navigation device 14 is transmitted to the automatic transmission control device 11 so as to change the shift speed of the automatic transmission 10 in accordance with the road shape ahead of the vehicle, and/or is transmitted to the engine control device 51 to change the output of the engine 52 in accordance with the road shape ahead of the vehicle position, thereby controlling travel of the vehicle.

For this purpose, the CPU 31 functions as a road shape estimating device, and a road shape estimation processing subunit 311 of the CPU 31 executes a road shape estimation routine to estimate the road shape, which routine will be described later. A travel control subunit of the CPU 31 executes travel control processing to transmit a signal for changing the shift speed of the automatic transmission 10 and/or for changing the output of the engine 52 according to the estimated road shape, to the automatic transmission control device 11 and/or the engine control device 51, or the like.

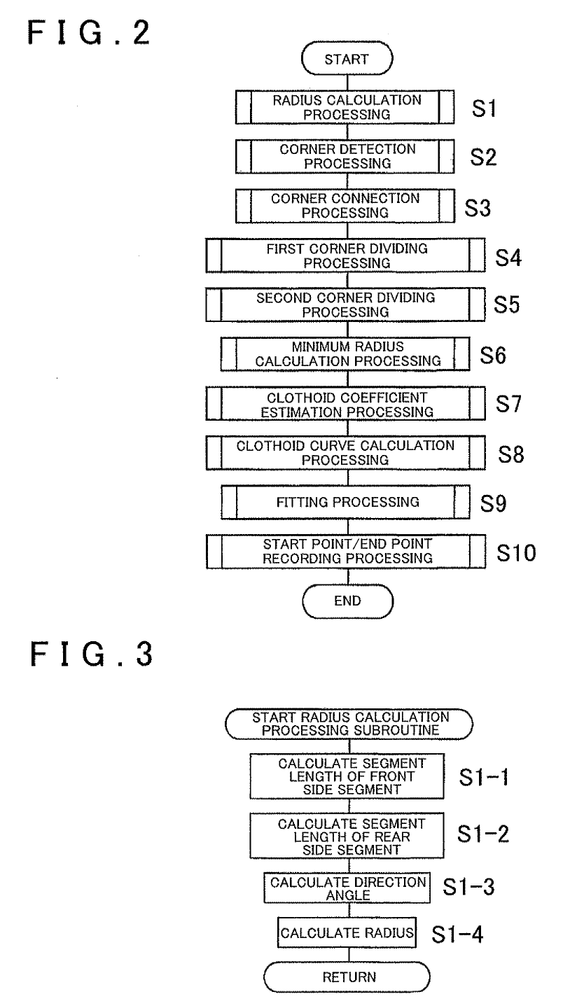

Next, operation of the road shape estimation processing unit will be explained according to FIG. 2.

First, a data obtaining processing unit 3111 of the road shape estimation processing unit 311 sets a predetermined region ahead of the vehicle position, including the road section for which road shape is to be determined, thereby establishing a road shape estimation range, and reads road data from the data recording unit 16 to obtain node data within the road shape estimation range.

Within the road shape estimation range, the road shape is estimated in a sequence of road links between nodes adjacent to each other, from the first node to the last node among the nodes represented by the node data.

In estimation of a road shape for each road link, the data obtaining processing subunit 3111 obtains data for shape interpolation points on the road link ahead of the vehicle location. The data obtaining processing subunit 3111, instead of reading the node data and the interpolation point data from the data recording unit 16, can obtain that data, via a network, from a remote information center.

Next, a radius calculation processing unit 3112 of the road shape estimation processing unit 311 calculates a radius (radius of curvature) for each shape interpolation point of the road link by a three-point calculation method, based on the data for shape interpolation points on the road link ahead of the vehicle location. Subsequently, a corner detection processing unit 3113 of the road shape estimation processing unit 311 executes a corner detection process to detect a corner in the road link based on the radius of curvature, and sets a shape interpolation point where the corner starts as a candidate start point, and a shape interpolation point where the corner ends in the database as a candidate end point.

When a corner that is actually a single corner is detected as a plurality of corners, because of the manner in which the shape interpolation points are set in the database, a corner connection processing unit 3114 of the road shape estimation processing unit 311 then executes a corner connection routine so as to connect the detected corners.

Conversely, when corners that are actually a plurality of corners are detected as one corner because a shape interpolation point is not set in a straight section between corners or because a shape interpolation point has a radius that is equal to or smaller than a threshold value for corner detection, first and second corner dividing processing units 3115 and 3116 of the road shape estimation processing unit 311 execute first and second corner dividing routines to divide what has been detected as a single corner. The first corner dividing routine is executed to divide the detected corner when a predetermined shape interpolation point in the corner has a radius that is equal to or larger than a threshold (first dividing condition). The second corner dividing routine is executed to divide the detected corner when a segment between predetermined shape interpolation points in the corner has a length that is equal to or longer than a threshold (second dividing condition).

When connection of corners or dividing of a corner is performed to set an appropriate corner based on shape interpolation points, a minimum radius calculation processing unit 3117 of the road shape estimation processing unit 311 executes minimum radius calculation processing to calculate an appropriate minimum radius for estimating a clothoid coefficient for each corner.

Subsequently, a clothoid coefficient estimation processing unit 3118 of the road shape estimation processing unit 311 executes clothoid coefficient estimation processing to estimate a clothoid coefficient based on the minimum radius. A clothoid curve calculation unit 3119 of the road shape estimation processing unit 311 executes clothoid curve calculation processing to obtain an approximate equation for the corner based on the clothoid coefficient and to calculate a clothoid curve.

In this manner, when the clothoid curve representing the road shape of the corner is calculated, a fitting processing unit 3120 of the road shape estimation processing unit 311 executes fitting processing to correct the candidate start point and the candidate end point by matching the clothoid curve with the respective shape interpolation points on the corner, and thereby sets the start point and the end point of the corner to positions approximating a point where the corner starts and a point where the corner ends on the actual road.

Then a start point/end point recording unit 3121 of the road shape estimation processing unit 311 performs start point/end point recording to record the start point and the end point as data representing the road shape in the data recording unit 16. In this manner, the road shape is estimated.

Next, the flowchart of FIG. 2 will be explained.

In step S1, the radius calculation processing is performed.

In step S2, the corner detection processing is performed.

In step S3, the corner connection processing is performed.

In step S4, the first corner dividing processing is performed.

In step S5, the second corner dividing processing is performed.

In step S6, the minimum radius calculation processing is performed.

In step S7, the clothoid coefficient estimation processing is performed.

In step S8, the clothoid curve calculation processing is performed.

In step S9, the fitting processing is performed.

In step S10, the start point/end point recording processing is performed, and the routine is finished.

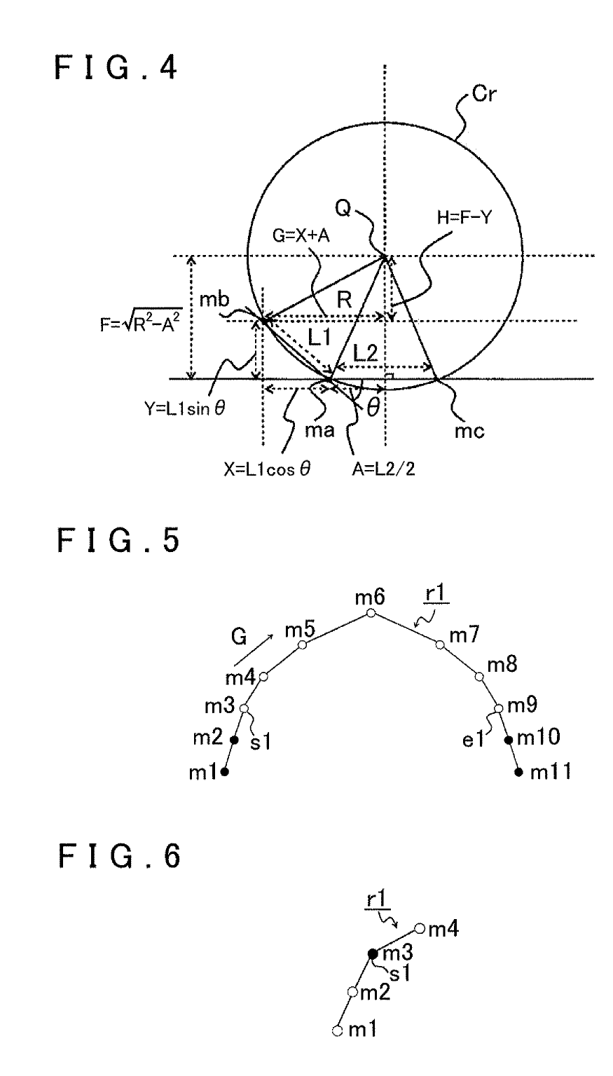

Next, the subroutine of the radius calculation processing in step S1 of FIG. 2 will be explained with reference to FIG. 3 which is a flowchart of the subroutine for the radius calculation processing in the embodiment of the present invention, and FIG. 4 which is a diagram explaining the principle of calculating a radius in an embodiment of the present invention.

As shown in FIG. 4, a shape interpolation point for which a radius of curvature is to be calculated is designated as target point ma, a shape interpolation point that is located immediately preceding the target point ma (on the vehicle position side) is designated as preceding adjacent point mb, and a shape interpolation point that is located immediately succeeding the target point ma (on the side opposite the vehicle position) is designated as succeeding adjacent point mc. The segment length of a segment on a side nearer than the target point ma (hereinafter referred to as “front side segment”) that connects the target point ma and the preceding adjacent point mb is designated as L1, and the segment length of a segment on a side farther than the target point ma (hereinafter referred to as “rear side segment”) that connects the target point ma and the succeeding adjacent point me is designated as L2. Further, when the circle passing through the target point ma, the preceding adjacent point mb and the succeeding adjacent point mc is designated as Cr, the center of the circle Cr is designated as Q and the radius of the circle Cr is designated as R. Furthermore, at the target point ma, the angle which the rear side segment forms with respect to the front side segment is designated as direction angle θ.

The direction in which the target point ma is connected with the succeeding adjacent point mc is designated by the x-axis and a direction at a right angle to the x axis direction is designated the y-axis, and when the distance between the target point ma and the preceding adjacent point mb in the x-axis direction is designated as X, the distance between the target point ma and the center Q in the x-axis direction is designated as A, the distance between the preceding adjacent point mb and the center Q in the x-axis direction is designated as G, the distance between the target point ma and the preceding adjacent point mb in the y-axis direction is Y, the distance between the preceding adjacent point mb and the center Q in the y-axis is designated as H, and the distance between the target point ma and the center Q on the y-axis direction is designated as F. Given the foregoing definitions, the following equations hold true:

X=L1 cos θ

A=L2/2

G=X+A

Y=L1 sin θ

F=√(R²−A²)

H=F−Y

In this case, the sum of the square of the distance G and the square of the distance H is equal to the square of the radius R, and thus equation (1) is satisfied.

R²=G²+H² (1)

Next, by substituting the above respective values into the distances G, H of the equation (1), the following equation (2) can be obtained.

R²=X²+2XA+A²+R²−A²−2Y√(R²−A²)+Y² (2)

Subsequently, by modifying equation (2), equations (3) to (6) can be obtained.

2Y√(R²−A²)=X²+Y²+2XA (3)

R²−A²={(X²+Y²+2XA)/2Y}² (4)

R²={(X²+Y²+2XA)/2Y}²+A² (5)

R²=(L1²+2L1·L2·cos θ+L2²)/(2 sin θ)² (6)

From the equation (6), it can be seen that the radius R is a function of the segment lengths L1, L2 and the direction angle θ.

Accordingly, the radius calculation processing unit reads the interpolation point data, calculates the segment lengths L1, L2 based on, respectively, the coordinates of the target point ma, the coordinates of the preceding adjacent point mb and the coordinates of the succeeding adjacent point mc, and calculates the direction angle θ.

Subsequently, the radius calculation processing unit calculates the radius R of the circle Cr by the aforementioned equation (6) based on the segment lengths L1, L2 and the direction angle θ. In this manner, the radius R at the target point ma can be calculated on the road link.

Next, the flowchart of FIG. 3 will be explained.

In step S1-1, the segment length L1 of the front side segment is calculated.

In step S1-2, the segment length L2 of the rear side segment is calculated.

In step S1-3, the direction angle θ is calculated.

In step S1-4, the radius R is calculated and the process returns to the main routine.

Note that in this embodiment, the direction angle θ and the radius R are calculated by the radius calculation processing unit 3112, but it is also possible to record a direction angle θ and a radius R, which are calculated in advance, in the database of the data recording unit 16 as part of the road data, and then to read them from the data recording unit 16.

Next, the corner detection processing in step S2 of FIG. 2 will be explained with reference to FIGS. 5-13.

In the diagrams, ri (i=1, 2, . . . ) is a road link set between two nodes (not shown), mi (i=1, 2, . . . ) are a plurality of shape interpolation points set in order in the direction of travel of the vehicle (the direction of arrow G) along the road link ri, and θi (i=1, 2, . . . ) are direction angles at respective shape interpolation point mi. Note that the direction angle θi is the angle which the rear side segment forms with respect to the front side segment. When the rear side segment is located on the right side in the direction of travel of the vehicle, relative to the front side segment, the direction angle θi has a positive value. When the rear side segment is located on the left side in the direction of travel of the vehicle, relative to the front side segment, the direction angle θi has a negative value.

First, a candidate start point/candidate end point setting processing unit of the corner detection processing unit 3113 executes candidate start point/candidate end point setting processing to read the radius Ri (i=1, 2, . . . ) at each shape interpolation point mi, determines whether the radius Ri is equal to or smaller than a threshold Rth (1000 [m] in this embodiment) for corner detection which is set in advance, and extracts any shape interpolation point with a radius equal to or smaller than the threshold Rth. In FIG. 5, the shape interpolation points m3 to m9 are close to a straight line, and they are determined to be equal to or lower than the threshold Rth and extracted.

Subsequently, the candidate start point/candidate end point setting processing unit determines whether or not there are a plurality of consecutive shape interpolation points (hereinafter referred to as a “consecutive shape interpolation point group”) among the extracted shape interpolation points. When there are consecutive shape interpolation points, the unit takes the shape interpolation point on the nearest side (vehicle position side) in the consecutive shape interpolation point group as a candidate start point. In FIG. 5 and FIG. 6, the consecutive shape interpolation point group is formed by the shape interpolation points m3 to m9, and the shape interpolation point m3 is taken as the candidate start point s1.

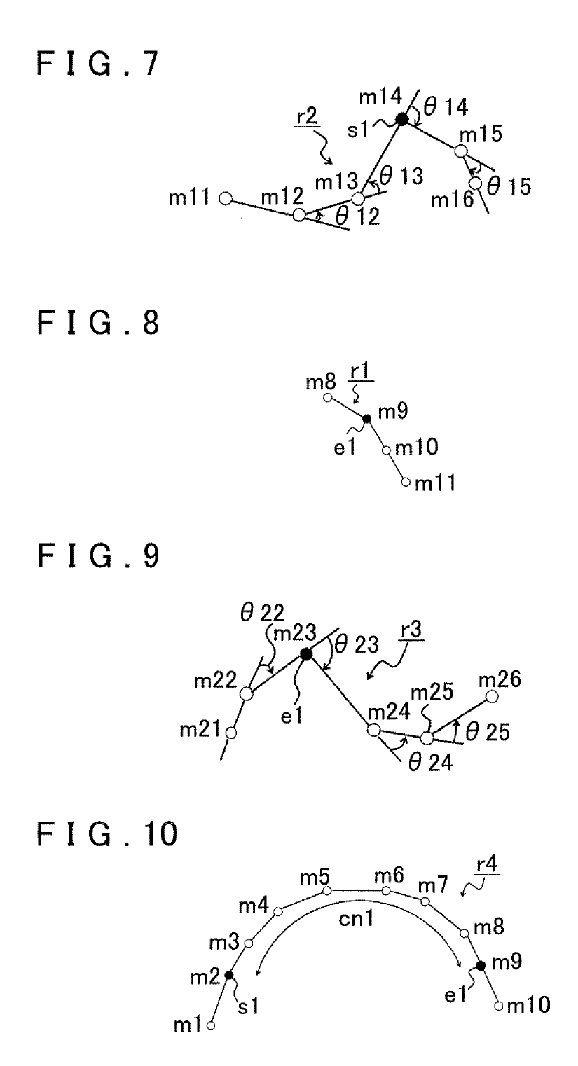

The candidate start point/candidate end point setting processing unit reads the direction angles θ calculated by the radius calculation processing unit for the extracted shape interpolation points sequentially from the near side, and determines whether or not the direction angle reverses from positive to negative or from negative to positive at a predetermined shape interpolation point (the direction of the direction angle reverses with respect to the immediately preceding shape interpolation point). When the direction angle reverses at the predetermined shape interpolation point, the unit determines whether or not the direction angle reverses at the immediately succeeding shape interpolation point. Then, when the direction angle reverses at the predetermined shape interpolation point but not at the immediately succeeding shape interpolation point, the predetermined shape interpolation point is taken as the candidate start point. When shape interpolation points m11 to m16 are set on a road link r2 having a shape as shown in FIG. 7, direction angles θ12 and θ13 take negative values and direction angles θ14 and θ15 take positive values at the shape interpolation points m12 to m15. That is, the direction angle θ14 reverses from negative to positive at the shape interpolation point m14, and the direction angle θ15 remains positive and does not reverse at the immediately succeeding shape interpolation point m15. Thus, the shape interpolation point m14 is taken as the candidate start point s1.

Next, the candidate start point/candidate end point setting processing unit determines whether or not there is a consecutive shape interpolation point group among the extracted shape interpolation points. When there is a consecutive shape interpolation point group, the unit takes the shape interpolation point on the farthest from the vehicle location in the consecutive shape interpolation point group as a candidate end point. In FIG. 5 and FIG. 8, the consecutive shape interpolation point group is formed by the shape interpolation points m3 to m9, and the shape interpolation point m9 is taken as the candidate end point e1.

Further, the candidate start point/candidate end point setting processing unit determines whether the direction angle changes between positive and negative at a predetermined shape interpolation point. When the positive or negative value of the direction angle does not reverse at the predetermined shape interpolation point, the unit determines whether or not it reverses at the immediately succeeding shape interpolation point. Then, when the positive or negative value of the direction angle does not reverse at the predetermined shape interpolation point and does reverse at the immediately succeeding shape interpolation point, the predetermined shape interpolation point is taken as a candidate end point. When shape interpolation points m21 to m26 are set on road link r3 having a shape as shown in FIG. 9, direction angles θ22 and θ23 take positive values and direction angles θ24 and θ25 take negative values at the shape interpolation points m22 to m25. That is, the direction angle θ23 remains positive and does not reverse at the shape interpolation point m23, and the direction angle θ24 reverses from positive to negative at the immediately succeeding shape interpolation point m24. Thus, the shape interpolation point m23 is taken as a candidate end point e1.

When the candidate start point and the candidate end point have been set, a corner setting processing unit of the corner detection processing unit executes corner setting processing, and sets a corner between the candidate start point and the candidate end point. On road link r4 having a shape as shown in FIG. 10, a shape interpolation point m2 is taken as the candidate start point s1, the shape interpolation point m9 is taken as the candidate end point e1, and a corner cn1 between the candidate start point s1 and the candidate end point e1 is set.

Note that when the radius of the predetermined shape interpolation point is equal to or smaller than the threshold Rth and both the radius of the immediately preceding shape interpolation point and the radius of the immediately succeeding shape interpolation point are larger than the threshold Rth, the candidate start point/candidate end point setting processing unit sets the predetermined shape interpolation point as a single point combining a candidate start point and a candidate end point, and the corner setting processing unit sets a corner to the predetermined shape interpolation point. On a road link r5 having a shape as shown in FIG. 11, a shape interpolation point m33 is set as a single point f1, and a corner cn1 is set at the shape interpolation point m33.

Furthermore, when the direction angle value reverses from positive to negative or from negative to positive at the predetermined shape interpolation point and at the immediately succeeding shape interpolation point, the candidate start point/candidate end point setting processing unit sets the predetermined shape interpolation point as a single point.

On a road link r6 having the shape shown in FIG. 12, direction angles θ42 to θ44, θ46 and θ47 at shape interpolation points m42 to m44, m46 and m47 have positive values, and direction angle θ45 at a shape interpolation point m45 has a negative value. In this case, the direction angle θ45 reverses from positive to negative at the shape interpolation point m45, and the direction angle θ46 reverses from negative to positive at the immediately succeeding shape interpolation point m46. Thus, the shape interpolation point m45 is set as a single point f1 and a corner cn1 is set at the shape interpolation point m45.

Subsequently, the corner setting processing unit sets three corners cn1 to cn3 before and after the single point f1 and at the single point f1. Note that, in this case, the numbers of the corners are added sequentially from the near side, and the number of a candidate start point and the number of a candidate end point are added corresponding to the numbers of the corners.

In this manner, when a corner is set on a road link, the recording processing unit of the corner detection processing unit records the number of corners in the road link, the number of a candidate start point, and the number of a candidate end point in the RAM 32 (FIG. 1).

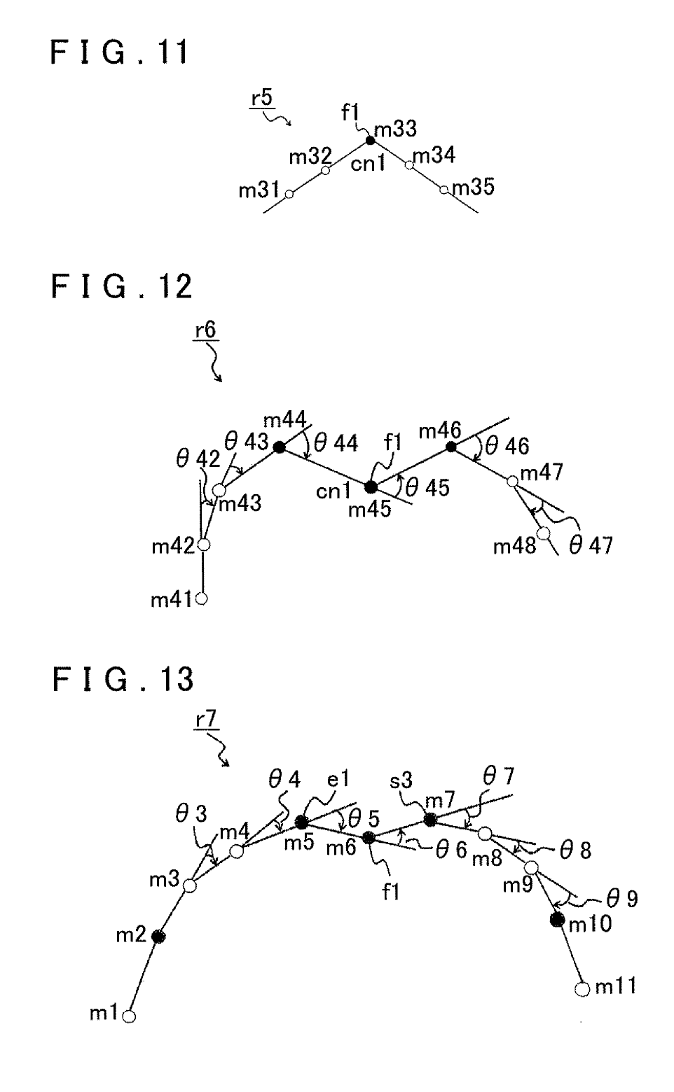

When precision of the interpolation point data in the database is low and a predetermined shape interpolation point as set deviates from a straight line in a straight section of a corner, it is possible that a plurality of actual corners have been detected and set as one corner in the database by the corner determination processing unit, and a candidate start point and a candidate end point for one corner only have been set. For example, on a road link r7 having a shape close to a trapezoid as shown in FIG. 13, a shape interpolation point m6, which should normally be set on a straight line connecting shape interpolation points m5, m7, as set, deviates from the straight line connecting the shape interpolation points m5, m7.

In this case, radii R2 to R10 at shape interpolation points m2 to m10 calculated in the radius calculation processing are equal to or smaller than the threshold Rth and the direction angles do not reverse between positive and negative at the shape interpolation points m2 to m10. Thus, in the corner detection processing, one corner cn1 is detected among the shape interpolation points m2 to m10.

Accordingly, in this embodiment, when corners that should be regarded as a plurality of corners are detected and recorded as one corner in the database, dividing of the corner is executed by the first corner dividing processing unit.

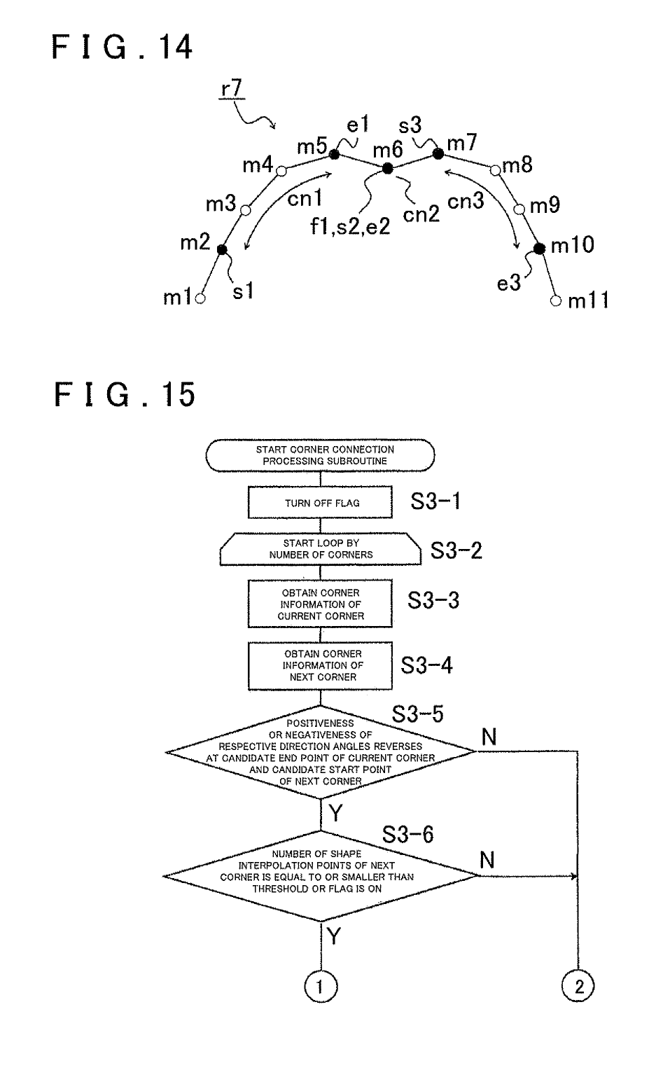

Next, the subroutine of the first corner dividing processing in step S4 of FIG. 2 will be explained with reference to FIGS. 14-18.

First, a corner information obtaining processing unit (radius basis) of the first corner dividing processing unit 3115 obtains corner information for predetermined corners in a road link by reading it from the RAM 32. In this case, respective corners in the road link are selected in sequence as predetermined corners.

Note that the corner information includes the numbers of a candidate start point and a candidate end point of each corner recorded in the RAM 32 in addition to the interpolation point data. In this embodiment, the first corner dividing processing is executed for the road link r7 of FIG. 13. Thus, the corner information obtaining processing unit obtains the number of a corner cn1, the number of a candidate start point s1 of the corner cn1, the number of a candidate end point e1 of the corner cn1, the respective numbers of shape interpolation points m2 to m10, and radii R2 to R10 at the respective shape interpolation points m2 to m10.

Subsequently, a dividing condition determination processing unit of the first corner dividing processing unit 3115 reads the numbers of the shape interpolation points, calculates the number of shape interpolation points in a corner, and determines whether or not a first dividing condition for performing the first corner dividing routine (processing) has been satisfied, i.e. determines whether the number of shape interpolation points is equal to or larger than a threshold, which threshold is three in this embodiment. On the road link r7 of FIG. 13, the number of shape interpolation points m2 to m10 in the corner cn1 is nine, and thus the first dividing condition is met.

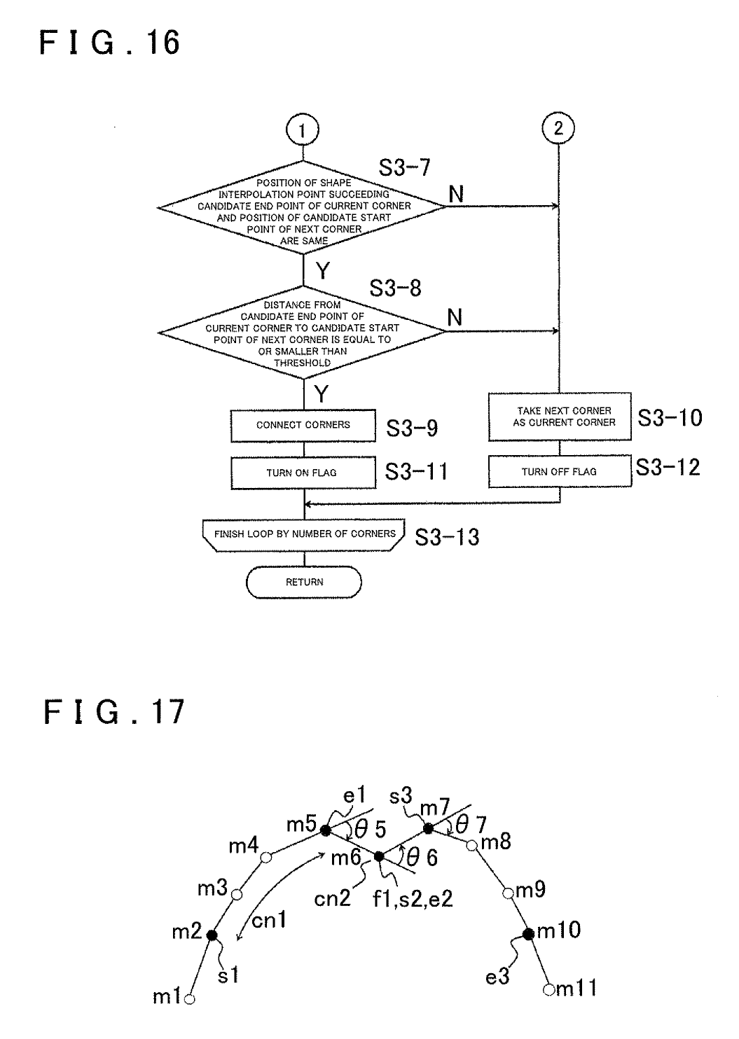

For example, in road link r8 of FIG. 15, a shape interpolation point m53 alone among shape interpolation points m51 to m55 has a radius equal to or smaller than the threshold. However, because the number of shape interpolation points in the corner is one (m53), i.e. three or more shape interpolation points are not included in the corner, the first dividing condition is not met. Further, on road link r9 of FIG. 16, m63, m64 are those shape interpolation points among shape interpolation points m61 to m66 which have radii equal to or smaller than the threshold and a corner is detected, but the number of shape interpolation points in the corner is two m63, m64, not three or more, and the first dividing condition is not met.

Next, the dividing condition determination processing unit determines whether a radius at a predetermined shape interpolation point in the corner is larger as compared to respective radii at other shape interpolation points in the corner. For this purpose, the dividing condition determination processing unit reads radii at respective shape interpolation points in the corner and determines whether or not a second dividing condition is met by determining whether the predetermined shape interpolation point in the corner has a radius equal to or larger than a threshold for a first dividing condition determination, calculated based on the radii at the respective shape interpolation points in the corner, that is, first dividing threshold Rthcn.

For this purpose, an average radius calculation processing unit of the dividing condition determination processing unit calculates an average radius value Ra for radii R2 to R10 at respective shape interpolation points m2 to m10. Subsequently, a threshold calculation processing unit of the dividing condition determination processing unit calculates the first dividing threshold Rthcn as:

Rthcn=Ra+3·σ1

wherein σ1 is the: standard deviation calculated based on the average value Ra. On a road link r7 of FIG. 17, when shape interpolation point m6 has a radius R6 equal to or larger than the first dividing threshold Rthcn, the second dividing condition is met. Note that the standard deviation σ1 is an added value set corresponding to the average value Ra.

Subsequently, when the first and second dividing conditions are met, a division execution processing unit of the dividing condition determination processing unit divides the corner at a shape interpolation point having a radius equal to or larger than the first dividing threshold Rthcn. Specifically, the division execution processing unit adds the shape interpolation point immediately preceding the shape interpolation point having a radius equal to or larger than the first dividing threshold Rthcn as a candidate end point, and adds the shape interpolation point immediately succeeding the shape interpolation point having a radius equal to or larger than the first dividing threshold Rthcn as a candidate start point. On the road link r7 of FIG. 17, the corner is divided at a shape interpolation point m6 having a radius equal to or larger than the first dividing threshold Rthcn. A shape interpolation point m2 is taken as a candidate start point s1, and the shape interpolation point m5 immediately preceding a shape interpolation point m6 is taken as a candidate end point e1. Then the shape interpolation point m7 immediately succeeding the shape interpolation point m6 is taken as a candidate start point s2, and a shape interpolation point m10 is taken as a candidate end point e2.

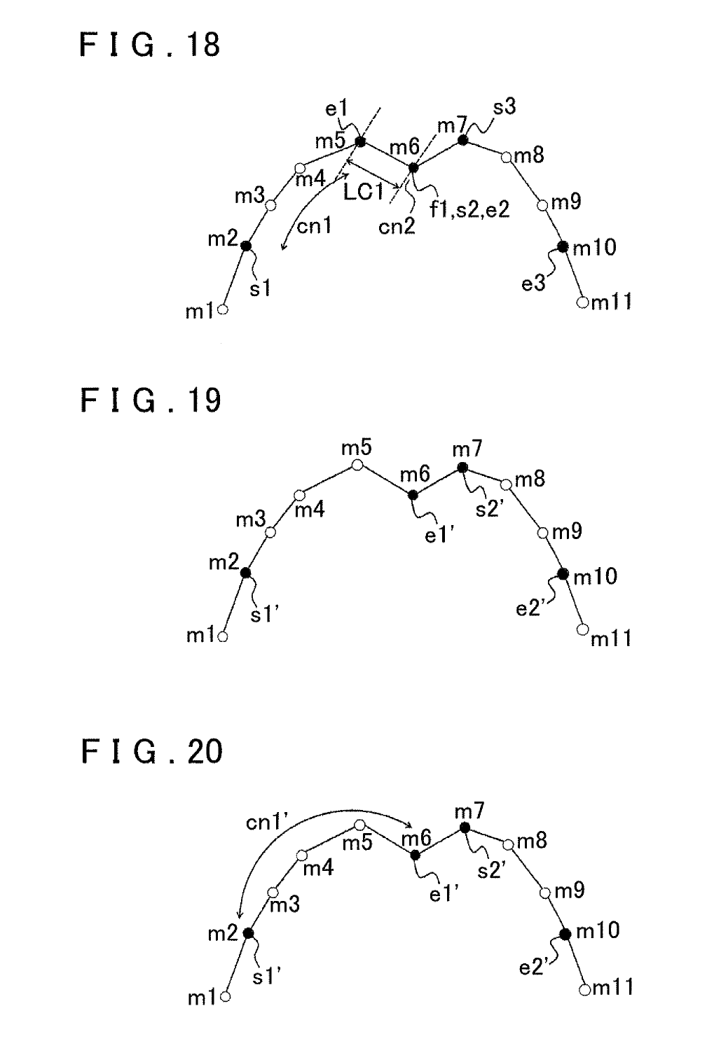

In this manner, in this embodiment, as shown in FIG. 18, a corner cn1 is set by the shape interpolation points m2 to m5 and a corner cn2 is set by the shape interpolation points m7 to m10.

Otherwise, when one of the first and second dividing conditions is not met, the corner division execution processing unit does not divide the current corner.

Accordingly, in this embodiment, even if the precision of the interpolation point data in the database is low and a predetermined shape interpolation point is set deviating from a straight line in a straight section of a corner, dividing of the corner is performed when both the first and second dividing conditions are met. Therefore, corners that should be regarded as a plurality of corners will not be recorded as one corner in the database, and thus the road shape can be estimated more precisely.

Further, since the first dividing threshold Rthcn is calculated by adding the standard deviation σ1 to the average value Ra, it becomes larger as the average value Ra becomes larger or becomes smaller as the average value Ra becomes smaller. Thus, even if noise is included in values of the respective radii R2 to R10, it is possible to precisely determine whether or not the second dividing condition is met.

Since the standard deviation σ1 represents the degree of variation between (“dispersion of”) the radii R2 to R10 at the respective shape interpolation points m2 to m10 of the corner, the threshold for dividing of the corner can be changed according to the degree of variation between the radii R2 to R10. Specifically, when the degree of variation between the radii R2 to R10 is high, the first dividing threshold Rthcn becomes large, which makes it difficult for the second dividing condition to be met, and makes it difficult for dividing of the corner to be performed. On the other hand, when the degree of variation between the radii R2 to R10 is low, the first dividing threshold Rthcn becomes small, which makes it easier for the second dividing condition to be met, and makes it more likely that the corner will be divided.

Therefore, the corner can be appropriately divided.

While the first dividing threshold Rthcn is described above as calculated by adding the standard deviation σ1 to the average value Ra, alternatively, first dividing thresholds Rthcn corresponding to average values Ra can be predetermined and stored in the data recording unit 16. In this alternative, a radius threshold map (first threshold map), in which the average values Ra are correlated with the first dividing thresholds Rthcn, is recorded in the ROM 33. In the division execution processing, the division execution processing unit refers to the radius threshold map to read the first dividing threshold Rthcn corresponding to the average value Ra, compares each of R2 to R10 with the first dividing threshold Rthcn, and divides the corner at a shape interpolation point having a radius equal to or larger than the first dividing threshold Rthcn.

Next, the flowchart of FIG. 14 will be explained.

In step S4-1, a control loop for the number of corners is started.

In step S4-2, corner information for the current corner is obtained.

In step S4-3, it is determined whether the number of shape interpolation points in the corner is three or more. When the number of shape interpolation points in the corner is three or more, the process proceeds to step S4-4. When the number of shape interpolation points in the corner is smaller than three, the process proceeds to step S4-7.

In step S4-4, the average value of radii of the shape interpolation points in the corner is calculated.

In step S4-5, the first dividing threshold Rthcn is calculated from the average value Ra.

In step S4-6, the corner is divided at a shape interpolation point having a radius equal to or larger than the first dividing threshold Rthcn.

In step S4-7, the control loop for the number of corners is finished, and the process is finished.

Now, as described above, when precision of the interpolation point data in the database is low and a shape interpolation point is not set in a straight section of a corner, it is possible that corners that should be regarded as a plurality of corners on the actual road are detected as one corner and stored as one corner in the database by the corner detection processing, and a candidate start point and a candidate end point of one corner are determined.

In road link r10, having a trapezoidal shape as shown in FIG. 19, no shape interpolation point is set in the straight section between shape interpolation points m5, m6.

In this case, radii R2 to R9 calculated for shape interpolation points m2 to m9 are equal to or lower than the threshold Rth, and the direction angles do not reverse between positive and negative values at the shape interpolation points m2 to m9. Thus, in the corner detection, one corner cn1 is detected for the shape interpolation points m2 to m9.

Accordingly, in this embodiment, dividing of the corner is performed by the second corner dividing processing unit.

Next, the subroutine of the second corner dividing processing in step S5 of FIG. 2 will be explained with reference to FIGS. 20-23.

First, a corner information obtaining processing unit (segment length basis) of the second corner dividing processing unit obtains corner information for predetermined corners in a road link by reading it from the RAM 32. Respective corners on the road link are selected in sequence as predetermined corners.

Note that the corner information includes the numbers of a candidate start point and a candidate end point for each corner recorded in the RAM 32 in addition to the interpolation point data. This embodiment utilizes the second corner dividing process for a road link r10. Thus, the corner information obtaining processing unit obtains the number of a corner cn1, the number of a candidate start point s1 of the corner cn1, the number of a candidate end point e1 of the corner cn1, the respective numbers of shape interpolation points m2 to m9, and segment lengths of respective segments between the respective shape interpolation points m2 to m9.

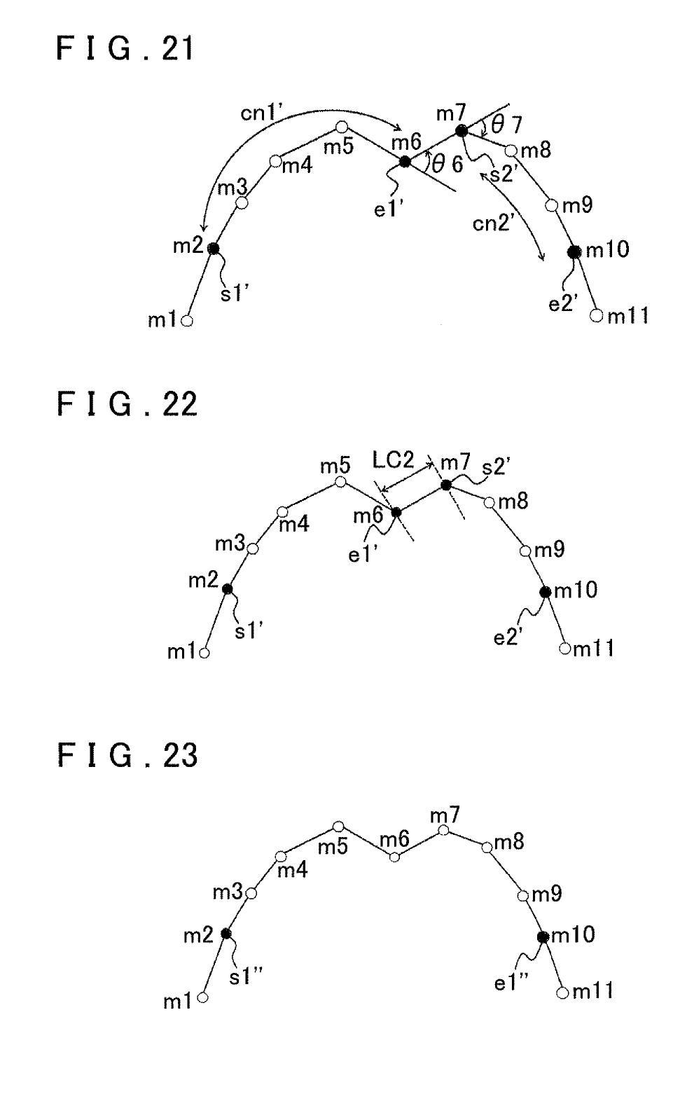

Subsequently, a dividing condition determination processing unit (segment length basis) of the second corner dividing processing unit reads the numbers of the shape interpolation points, calculates the number of shape interpolation points in a corner, and determines whether or not a first dividing condition for performing a second corner dividing processing is met by whether the number of shape interpolation points is equal to or larger than a threshold, which is three in this embodiment. On the shape estimation road r10 of FIG. 21, the number of shape interpolation points m2 to m9 in the corner cn1 is eight, and thus the first dividing condition is met.

For example, as described above, since three or more shape interpolation points are not included in the corners in the shape estimation road r8 of FIG. 15 and the shape estimation road r9 of FIG. 16, the first dividing condition is not met.

Next, the dividing condition determination processing unit determines whether a segment length between predetermined shape interpolation points in the corner is relatively longer as compared to respective segment lengths between other shape interpolation points in the corner. For this purpose, the dividing condition determination processing unit reads the segment lengths between respective shape interpolation points in the corner, and determines whether a second dividing condition is met or not by whether segments between predetermined shape interpolation points in the corner have segment lengths equal to or larger than a threshold for a second dividing condition determination calculated based on the segment lengths between respective shape interpolation points in the corner, that is, a second dividing threshold Lthcn.

For this purpose, an average segment length calculation processing unit of the dividing condition determination processing unit performs average segment length calculation processing to calculate an average value La of the segment lengths between the respective shape interpolation points m2 to m9. Subsequently, the threshold calculation processing unit of the dividing condition determination processing unit then calculates the second dividing threshold Lthcn as:

Lthcn=La+3·σ2

wherein σ2 is the standard deviation calculated based on the average value La. In FIG. 21, when the segment Lc1 between the shape interpolation points m5, m6 has a segment length equal to or larger than the second dividing threshold Lthcn, the second dividing condition is met. Note that the standard deviation σ2 is an added value set corresponding to the average value La.

Subsequently, when the first, second diving conditions are met, the division execution processing unit (segment length basis division execution processing unit) of the dividing condition determination processing unit performs division execution processing to divide the corner by a segment having a segment length equal to or larger than the second dividing threshold Lthcn. Further, the division execution processing unit takes the preceding shape interpolation point out of the shape interpolation points forming the segment having a segment length equal to or larger than the second dividing threshold Lthcn as a candidate end point, and takes the succeeding shape interpolation point out of the shape interpolation points forming the segment having a segment length equal to or larger than the second dividing threshold Lthcn as a candidate start point. In FIG. 22, the corner cn1 is divided by the segment between the shape interpolation points m5, m6 having a segment length Lc11 that is equal to or larger than the second dividing threshold Lthcn. A shape interpolation point m2 is taken as a candidate start point s1, the shape interpolation point m5 preceding the segment between the shape interpolation points m5, m6 is taken as a candidate end point e1, the shape interpolation point m6 succeeding the segment between the shape interpolation points m5, m6 is taken as a candidate start point s2, and a shape interpolation point m9 is taken as a candidate end point e2.

In this manner, in this embodiment, as shown in FIG. 23, a corner cn1 is formed by the shape interpolation points m2 to m5, and a corner cn2 is formed by the shape interpolation points m6 to m9.

Further, when one of the first and second dividing conditions is not met, the corner division execution processing unit does not divide the current corner.

Accordingly, in this embodiment, even if precision of the interpolation point data in the database is low and a shape interpolation point is not set in a straight section of a corner, dividing of the corner is performed when the first and second dividing conditions are met. Therefore, corners that should be regarded as a plurality of corners on the actual road will not be regarded as one corner in the database, and thus the road shape can be estimated precisely.

Further, the second dividing threshold Lthcn is calculated by adding the standard deviation σ2 to the average value La, and it is set larger as the average value La gets larger or set smaller as the average value La gets smaller. Thus, when noise is included in the values of the respective segment lengths or the like, it is possible to precisely determine whether or not the second dividing condition is met.

Since the standard deviation σ2 represents the degree of variation between the respective segment lengths between the respective shape interpolation points m2 to m9 of the corner, the threshold for dividing of the corner can be changed according to the degree of variation between the segment lengths. Specifically, when the degree of variation between the segment lengths is high, the second dividing threshold Lthcn becomes large, which makes it difficult for the second dividing condition to be met, and makes it less likely that the corner will be divided. On the other hand, when the degree of variation between the segment lengths is low, the second dividing threshold Lthcn becomes small, which makes it easy for the second dividing condition to be met, and makes it more likely that the corner will be divided.

Therefore, dividing of the corner can be performed appropriately.

Note that in this embodiment, the second dividing threshold Lthcn is calculated by adding the standard deviation σ2 to the average value La, but a second dividing threshold Lthcn that is set in advance corresponding to the average value La can be recorded, for example, in the data recording unit 16.

In this case, a segment length threshold map as a second threshold map in which the average value La and the second dividing threshold Lthcn correspond to each other is recorded in the ROM 33. In the division execution processing, the division execution processing unit refers to the segment length threshold map to read the second dividing threshold Lthcn corresponding to the average value La, compares the segment lengths between the respective shape interpolation points m2 to m9 with the second dividing threshold Lthcn, and divides the corner by a segment having a segment length equal to or larger than the second dividing threshold Lthcn.

Next, the flowchart of FIG. 20 will be explained.

In step S5-1, a loop for the number of corners is started.

In step S5-2, corner information of the current corner is obtained.

In step S5-3, it is determined whether the number of shape interpolation points in the corner is three or more. When the number of shape interpolation points in the corner is three or more, the process proceeds to step S5-4. When the number of shape interpolation points in the corner is smaller than three, the process proceeds to step S5-7.

In step S5-4, the average value La of segment lengths in the corner is calculated.

In step S5-5, the second dividing threshold Lthcn is calculated from the average value La.

In step S5-6, the corner is divided by a segment having a segment length equal to or larger than the second dividing threshold Lthcn.

In step S5-7, the loop for the number of corners is finished, and the process is finished.

Next, the clothoid coefficient estimation processing in step S7 of FIG. 2 will be explained.

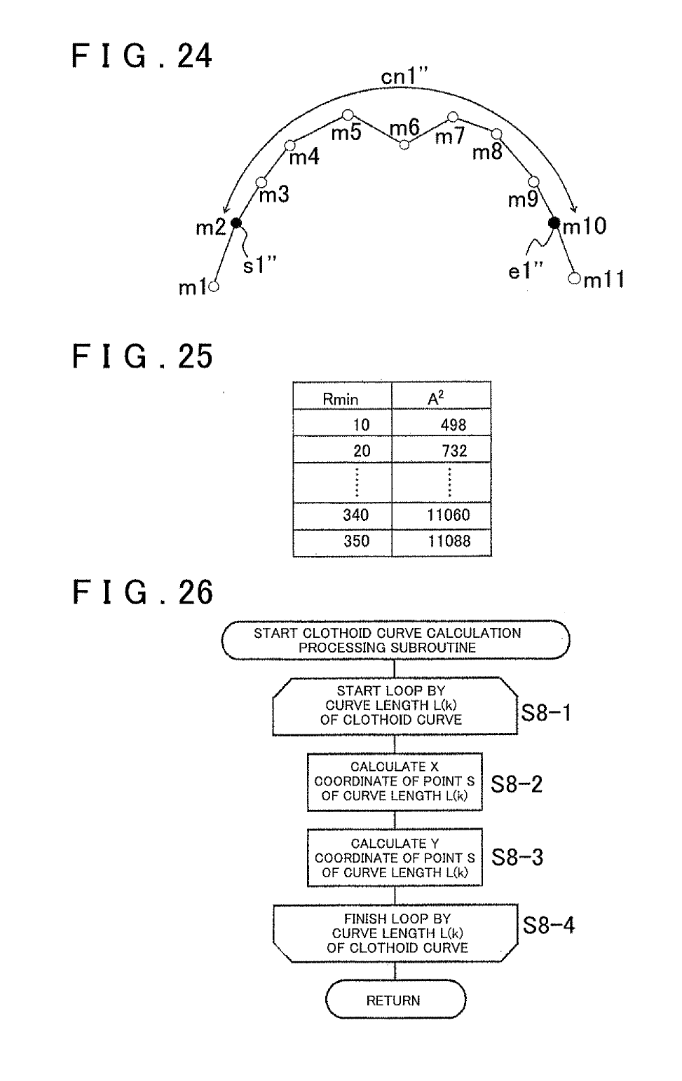

FIG. 24 is a table showing a clothoid coefficient map in the embodiment of the present invention.

In this case, minimum radii Rmin and square values A² of the clothoid coefficient A of a clothoid curve are recorded corresponding to each other as a clothoid coefficient map in the ROM 33 (FIG. 1), and the clothoid coefficient estimation processing unit reads the minimum radius Rmin calculated in aforementioned step S6, refers to the clothoid coefficient map, and reads the value A² corresponding to the minimum radius Rmin. Subsequently, the clothoid coefficient estimation processing unit calculates and estimates a clothoid coefficient A. Note that the clothoid coefficient map is created based on a relationship between a radius on the actual road and the clothoid coefficient of a clothoid curve that is used when designing this road.

Next, the subroutine for the clothoid curve calculation in step S8 of FIG. 2 will be explained.

FIG. 25 is a flowchart showing the subroutine of the clothoid curve calculation processing in the embodiment of the present invention.

Now, the clothoid curve is a curve having a radius of curvature that becomes smaller with distance from its origin. Generally, when a road is designed, a part of the clothoid curve is assigned to the start point or end point of a corner. To express the clothoid curve by x-y coordinates, when the distance from the start point (origin) of the clothoid curve to a predetermined point S, namely, a curve length is L, and a curve radius at the point S is Rc, following equation holds true.

L·Rc=A² (7)

Further, normally, the X coordinate and Y coordinate of the clothoid curve can be calculated by polynomials shown by equations (8) and (9), respectively.

X=L×(1−L²/(40Rc²)+L⁴/(3456Rc⁴)−L⁶/(599040Rc⁶)+L⁸/(175472640Rc⁸) . . . ) (8)

X=L²/(6Rc)×(1−L²/(56Rc²)+L⁴/(7040Rc⁴)−L⁶/(1612800Rc⁶)+L⁸/(588349440Rc⁸) . . . ) (9)

In this case, it is conceivable to calculate the clothoid curve by aforementioned equations (8) and (9), but since equations (8) and (9) are high-order polynomials, the load on the CPU 31 becomes large by clothoid curve calculation processing when an attempt is made to calculate the clothoid curve by plotting a large number of points.

Accordingly, in this embodiment, the clothoid curve is calculated based on the clothoid coefficient A calculated in the clothoid coefficient estimation processing by the clothoid curve calculation processing unit. Thus, the clothoid curve calculation processing unit approximates and calculates the X coordinate and the Y coordinate of the clothoid curve (point S of the curve length L (k)) by equations (10) and (11) obtained based on simulation.

$$\begin{matrix}[ Equation 1 ] & \\ X = {X}_{0} + {\sum }_{r} cos φ & ( 10 ) \\ Y = {Y}_{0} + {\sum }_{L} sin φ & ( 11 )\end{matrix}$$

Here, X₀ and Y₀ are X coordinate and Y coordinate of a start point of the clothoid curve. Further, angle φ is expressed by equation (12).

φ=α+2k·L (12)

Here, α is the direction of the start point of the clothoid curve, and value k is expressed by the following equation (13).

k=28/A² (13)

Next, the flowchart will be explained.

In step S8-1, a loop is started by the curve length L(k) of the clothoid curve.

In step S8-2, the X coordinate of the point S of the curve length L(k) is calculated.

In step S8-3, the Y coordinate of the point S of the curve length L(k) is calculated.

In step S8-4, the loop is finished by the curve length L(k) of the clothoid curve, and the process returns to the main routine.

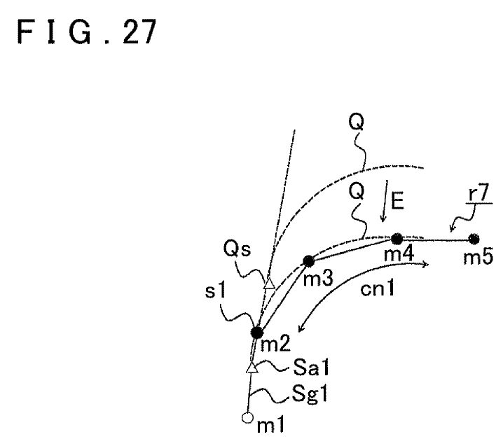

Next, the fitting processing in step S9 of FIG. 2 will be explained with reference to FIG. 26.

In the diagram, reference numeral r7 denotes a shape estimation road, reference numeral cn1 denotes a corner set by the corner connection processing and the first, second corner dividing processing, reference numerals m1 to m5 denote shape interpolation points forming the corner cn1, and reference numeral s1 denotes a candidate start point of the corner cn1.

In this case, a clothoid curve movement processing unit of the fitting processing unit performs clothoid curve movement processing to place the origin Qs of a clothoid curve Q on an extended line of the segment Sg1 connecting the shape interpolation points m1, m2, and move the clothoid curve Q in an arrow E direction so that a tangent line on the origin Qs and the extended line of the segment Sg1 correspond.

At this time, an error calculation processing unit of the fitting processing unit performs error calculation processing to calculate the sum of errors of the position of the clothoid curve Q with respect to the respective shape interpolation points m2 to m5 after the shape interpolation point m2. In this case, the errors of the position of the clothoid curve Q with respect to the respective shape interpolation points m2 to m5 are calculated based on a distance on the X-axis and a distance on the Y-axis between the shape interpolation points m2 to m5 and each point plotted when drawing the clothoid curve Q.

Then the clothoid curve movement processing unit matches the clothoid curve Q with the shape interpolation points m2 to m5 so that the sum of the errors becomes smallest, so as to set the position of the clothoid curve Q.

Subsequently, a start point/end point extraction processing unit of the fitting processing unit performs start point/end point extraction processing, and set the origin Qs of the clothoid curve Q as a start point Sa1 of the actual corner when the position of the clothoid curve Q is set.

Then the clothoid curve movement processing unit, the error calculation processing unit and the start point/end point extraction processing unit perform similar processing on the end point side of the corner cn1 so as to set the position of the clothoid curve Q, and then set the origin of the clothoid curve Q as an end point of the actual corner.

In this manner, the candidate start point and the candidate end point are corrected with the clothoid curve Q, and the collected candidate start point and candidate end point can be set as the start point and end point of the actual corner, respectively. Thus, the candidate start point and the candidate end point of the corner cn1 can be made close to the start point and the end point of a corner on the actual road.

Next, the start point/end point recording processing in step S10 of FIG. 2 will be explained.

The start point/end point recording processing unit records positions of extracted candidate start point and candidate end point as data representing the road shape in the data recording unit 16.

Thus, in this embodiment, a road shape can be estimated precisely, and the start point and the end point of an actual corner are set based on the precisely estimated road shape. Therefore, it is possible to precisely control travel of the vehicle by changing the shift speed of the automatic transmission 10 and/or the output of the engine 52 in accordance with the road shape.

In this embodiment, estimation of a road shape is performed by operation of the CPU 31 of the navigation device 14, but it is possible to estimate a road shape by operation of a CPU (not shown) of the automatic transmission control device 11 or by operation of a CPU as a control device of the information center. Note that a vehicle control device is disposed as a control device at a higher level than the automatic transmission control device 11 and the engine control device 51 so as to perform overall control of the entire vehicle, and it is also possible to estimate a road shape by operation of a CPU of this vehicle control device.

Further, in this embodiment, estimation of road shape is performed for a shape estimation road between adjacent nodes, but when a road shape is estimated for every shape estimation road between respective nodes in the case where there is a node in a corner on the actual road, the processing becomes different before and after the node in the corner. Accordingly, in another embodiment, road following data are added between respective road links in road data, and when a road link that is expected to be entered after passing the node is clear, or when a searched route is set by route search processing, estimation of road shape can be performed for two or more consecutive road links.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A road shape estimating device, comprising:
a data obtaining processing unit for obtaining interpolation point data for a plurality of shape interpolation points which are set along a road and represent a shape of the road;
a radius calculation processing unit for calculating a radius of curvature at each of the shape interpolation points based on the interpolation point data for a predetermined section of the road;
a corner detection processing unit for detecting a corner in the predetermined section based on the calculated radius of curvature at each of the shape interpolation points; and
a corner dividing processing unit for obtaining segment lengths of segments between respective shape interpolation points in the detected corner and for dividing the corner by a segment having a segment length equal to or larger than a threshold which is set corresponding to an average value of the respective segment lengths.

2. The road shape estimating device according to claim 1, wherein
the corner dividing processing unit sets a threshold corresponding to an average value of radii of curvature at respective shape interpolation points in the detected corner and divides the corner at a shape interpolation point having a radius of curvature equal to or larger than the threshold in the detected corner.

3. The road shape estimating device according to claim 1, wherein
the threshold is set corresponding to a degree of variation between the segment lengths.

4. A road shape estimating method, comprising the steps of:
obtaining interpolation point data for a plurality of shape interpolation points which are set along a road and represent a shape of the road;
calculating a radius of curvature at each of shape interpolation points based on the interpolation point data for a predetermined section of the road;
detecting a corner in the section based on the calculated radius of curvature at each of the shape interpolation points;
obtaining segment lengths of segments between respective shape interpolation points in the detected corner; and
dividing the corner by a segment having a segment length equal to or larger than a threshold which is set corresponding to an average value of the segment lengths.

5. A computer readable medium encoded with a program that causes a computer to perform the steps of:
obtaining interpolation point data for a plurality of shape interpolation points which are set along a road and represent a shape of the road;
calculating a radius of curvature at each of shape interpolation points based on the interpolation point data for a predetermined section of the road;
detecting a corner in the predetermined section based on the calculated radius of curvature at each of the shape interpolation points;
obtaining segment lengths of segments between respective shape interpolation points in the detected corner; and
dividing the corner by a segment having a segment length equal to or larger than a threshold which is set corresponding to an average value of the segment lengths.
